(19) United States
(12) Patent Application Publication
(10) Pub. No.: US 2005/0264491 A1
(43) Pub. Date: Dec. 1, 2005

(54) Plasma display panel and driving method of the same

(76) Inventor: Hoon-Young Choi, Suwon-si (KR)

Correspondence Address: MCGUIREWOODS, LLP, 1750 TYSONS BLVD, SUITE 1800, MCLEAN, VA, 22102, US

(21) Appl. No.: 11/095,602

(22) Filed: Apr. 1, 2005

(30) Foreign Application Priority Data
May 31, 2004 (KR) 10-2004-0038933

(51) Int. Cl. G09G 3/28

(52) U.S. Cl. 345/67

(57) ABSTRACT

A plasma display panel having enhanced discharge cell light emission efficiency while minimizing the increase in power consumption. The plasma display panel includes first and second substrates facing each other, address electrodes formed on the first substrate, and barrier ribs arranged between the first and the second substrates to partition discharge cells. Display electrodes are formed on the second substrate while crossing the address electrodes. The display electrodes have a first electrode provided at the discharge cells, and second electrodes are arranged at both sides of each discharge cell, while interposing the first electrode, independently of the neighboring discharge cells.

### CROSS REFERENCE TO RELATED APPLICATION

This application claims priority to and the benefit of Korean Patent Application No. 10-2004-0038933, filed on May 31, 2004, which is hereby incorporated by reference for all purposes as if fully set forth herein.

### BACKGROUND OF THE INVENTION

1. Field of the Invention

The present invention relates to a plasma display panel using plasma discharge, and a method of driving the same.

2. Description of the Background

Generally, a plasma display panel (PDP) displays images by exciting phosphors with vacuum ultraviolet rays generated by gas discharge within discharge cells. PDPs may be largely classified as alternating current (AC) and direct current (DC) types, depending upon voltage driving waveforms, and as interface and surface discharge types, depending upon electrode structure. The recent trend is to use the AC PDP with a triode surface discharge structure.

With the triode surface discharge AC PDP, a plurality of address electrodes, barriers ribs, and phosphor layers may be formed at a rear substrate corresponding to the respective discharge cells. A plurality of display electrodes, including scan electrodes and sustain electrodes, may be formed at a front substrate. A dielectric layer covers the address electrodes and the display electrodes, respectively. The discharge cells, where the address and the display electrodes cross each other, may be filled with a discharge gas, which may be mainly a mixture of Ne—Xe.

With the above structure, applying an address voltage (Va) between the address and the scan electrodes generates an address discharge to select target discharge cells. Applying a sustain voltage Vs between the scan and the sustain electrodes of selected discharge cells generates a plasma discharge within the selected discharge cells, thereby emitting vacuum ultraviolet rays from the excited atoms of the Xe. The vacuum ultraviolet rays excite the phosphors of the relevant discharge cells to emit visible rays, thereby displaying the desired images.

With the PDP, several operations are conducted from the inputting of power to the emission of the visible rays. Since energy conversion may not be effective in the operations, the PDP's efficiency (the ratio of the brightness to the power consumption) may be lower than that of the CRT. Accordingly, enhancing the device's efficiency by increasing screen brightness and reducing power consumption is desirable.

### SUMMARY OF THE INVENTION

The present invention provides a PDP, and a method of driving the same, that may enhance light emission efficiency within the discharge cells and minimize an increase in power consumption.

Additional features of the invention will be set forth in the description which follows, and in part will be apparent from the description, or may be learned by practice of the invention.

The present invention discloses a PDP including first and second substrates facing each other, address electrodes formed on the first substrate, barrier ribs arranged between the first and the second substrates to partition discharge cells, and display electrodes formed on the second substrate while crossing the address electrodes. The display electrodes comprise a first electrode (a Y or scan electrode) provided at the respective discharge cells, and second electrodes (X or sustain electrodes) arranged at both sides of each discharge cell in the longitudinal direction of the address electrodes, while interposing the first electrode, independently of the neighboring discharge cells.

The present invention also discloses a method of driving a PDP having first and second substrates, address electrodes formed on the first substrate, first electrodes (scan or Y electrodes) formed on the second substrate while crossing the address electrodes, and second electrodes (sustain or X electrodes) formed at both sides of each discharge cell, while interposing the first electrode, independently of the neighboring discharge cells. A frame is divided into a plurality of subfields, and the respective subfields have a reset period, a address period, and a sustain period. A reset signal is applied to the first electrode and the second electrodes within the reset period. A scan signal and an address pulse are applied to the first electrode and the address electrode within the address period, respectively. A sustain discharge pulse is alternately applied to the first electrode and the second electrodes within the sustain period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a partial exploded perspective view of a PDP according to a first exemplary embodiment of the present invention.

FIG. 2 is a partial plan view of the PDP shown in FIG. 1, illustrating the assembled state thereof.

FIG. 3 and FIG. 4 are partial sectional views showing the assembled state of the PDP shown in FIG. 1.

FIG. 5 is a waveform diagram of drive signals for driving a PDP according to an exemplary embodiment of the present invention.

FIG. 6 is partial plan view of a PDP according to a second exemplary embodiment of the present invention.

### DETAILED DESCRIPTION OF PREFERRED EMBODIMENTS

The present invention will be described more fully hereinafter with reference to the accompanying drawings showing exemplary embodiments of the present invention.

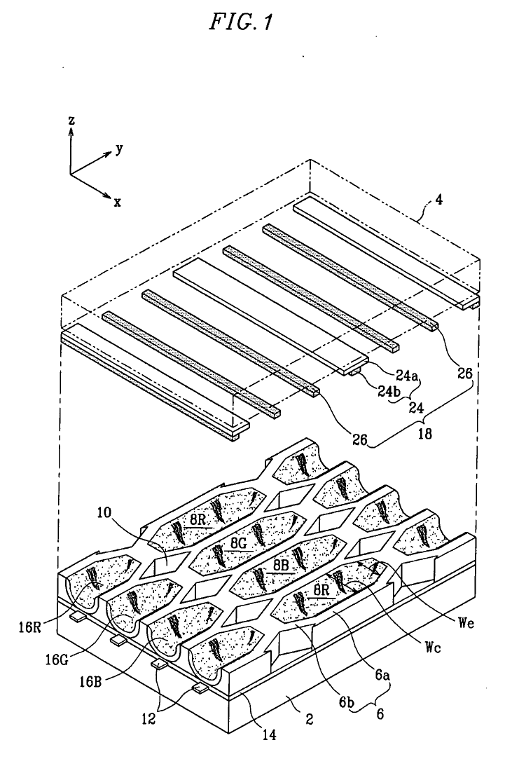

FIG. 1 is a partial exploded perspective view of a PDP according to a first exemplary embodiment of the present invention.

As shown in FIG. 1, the PDP includes first and second substrates 2 and 4 facing each other with a predetermined distance therebetween. Barrier ribs 6 may be formed between the first and the second substrates 2 and 4 to define discharge cells 8R, 8G, and 8B and non-discharge regions 10. A discharge gas, such as a mixture of gas including Ne—Xe, may be charged into the discharge cells 8R, 8G, and 8B.

Address electrodes 12 may be formed on an inner surface of the first substrate 2 and in the y axis direction of the drawing, and a first dielectric layer 14 may cover the address electrodes 12. The address electrodes 12 may be formed in a parallel stripe pattern, and they may be spaced apart from each other by a distance of the discharge cell pitch in the x axis direction.

Barrier ribs 6 may be arranged on the first dielectric layer 14 to define the discharge cells 8R, 8G, and 8B and the non-discharge regions 10. The discharge cells 8R, 8G, and 8B are spaces where gas discharge and light emission occur, and the non-discharge regions 10 are spaces where gas discharge and light emission generally do not occur. As the drawings show, the discharge cells 8R, 8G, and 8B and the non-discharge regions 10 may be formed with a separate cell structure.

Specifically, the barrier ribs 6 partition the discharge cells 8R, 8G, and 8B in the longitudinal direction of the address electrodes 12 (the y axis direction), and in a direction perpendicular to the address electrodes 12 (the x axis direction). The respective discharge cells may be optimally shaped considering the diffusion pattern of the discharge gas.

The optimized structure of the discharge cells 8R, 8G, and 8B may be made by minimizing the portions of the discharge cells 8R, 8G, and 8B that do little to enhance the sustain discharge and the brightness. In other words, ends of the discharge cells 8R, 8G, and 8B are narrower than their centers.

That is, as FIG. 1 shows, the width Wc of the center portion of the discharge cells 8R, 8G, and 8B is wider than the width We of the ends thereof. The width We of the ends of the discharge cells narrows when moving farther from the center thereof. Consequently, both ends of the discharge cells 8R, 8G, and 8B may form a trapezoid, and the overall plane shape of the discharge cells 8R, 8G, and 8B may be an octagon.

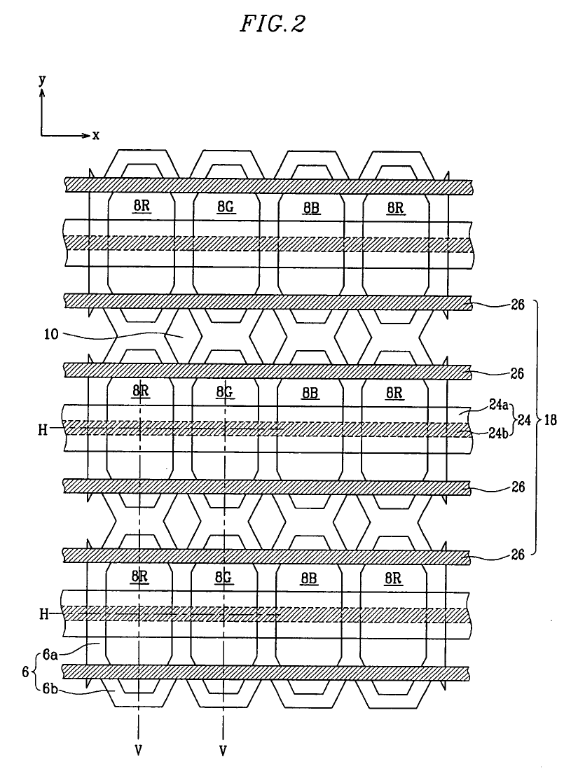

FIG. 2 is a partial plan view showing an assembled state of the PDP shown in FIG. 1.

The barrier ribs 6, the discharge cells 8R, 8G, and 8B and the non-discharge regions 10 will be now explained with reference to FIG. 2. The non-discharge regions 10 may be placed within an area surrounded by the imaginary horizontal and vertical axis lines H and V drawn over the centers of the discharge cells 8R, 8G, and 8B. The center of the non-discharge region 10 may correspond to the center of a region surrounded by the horizontal and the vertical axis lines H and V. That is, with such a structure, a common non-discharge region 10 may be placed among a pair of discharge cell neighbors in the longitudinal direction of the address electrodes 12 (the Y axis direction) and a pair of discharge cell neighbors in the direction perpendicular to the address electrodes 12 (the X axis direction).

The barrier ribs 6 may comprise first barrier rib members 6a proceeding parallel to the address electrodes 12, and second barrier rib members 6b crossing the address electrodes 12 while interconnecting the first barrier rib members 6a. The second barrier rib members 6b may cross the first barrier rib members 6a at both sides of the discharge cells 8R, 8G, and 8B (in the Y axis direction) with a predetermined inclination angle. The first exemplary embodiment of the present invention shows X-shaped second barrier rib members 6b between neighboring discharge cells in the longitudinal direction of the address electrodes 12 (the Y axis direction).

Red, green, and blue phosphors may be applied within the discharge cells 8R, 8G, and 8B to form phosphor layers 16R, 16G, and 16B.

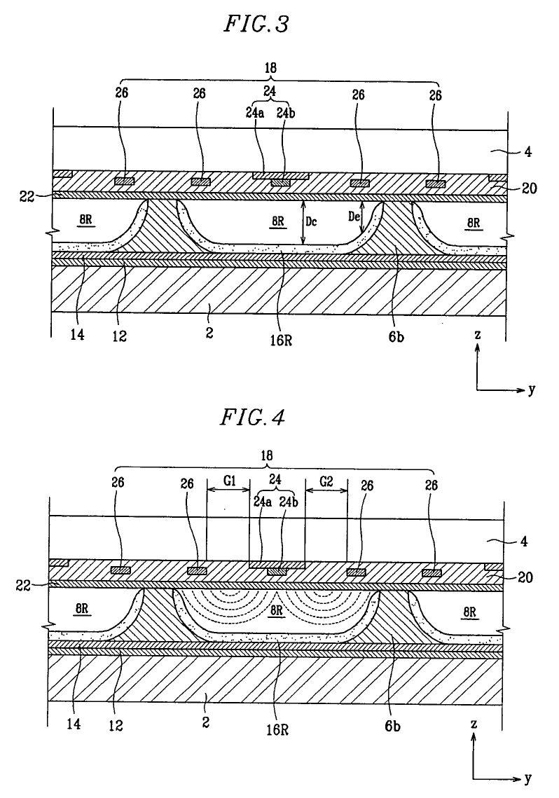

FIG. 3 and FIG. 4 are partial sectional views showing an assembled state of the PDP of FIG. 1.

Referring to FIG. 3, the cell depth De at both ends of the discharge cell 8R in the Y axis direction decreases when moving away from the center of the discharge cell 8R. That is, the cell depth De at the ends of the discharge cell 8R is less than the cell depth Dc at the center thereof, and the cell depth De gradually reduces when moving away from the center thereof. The depth characteristic of the red discharge cell 8R may similarly apply to the green discharge cell 8G and the blue discharge cell 8B.

Display electrodes 18 may be formed on a surface of the second substrate 4 facing the first substrate 2 and in the direction crossing the address electrodes 12 (the X axis direction). A second dielectric layer 20 may cover the display electrodes 18, and a protective layer 22, which may be made of MgO, may cover the second dielectric layer 20. For simplification, the second dielectric layer 20 and the protective layer 22 are omitted in FIG. 1.

The display electrodes 18 may comprise first electrodes 24 (referred to as the scan electrodes or the Y electrodes Yₙ where n is 1, 2, 3 . . . ) operating with the address electrodes 12 to select the target discharge cells 8R, 8G, and 8B, and second electrodes 26 (referred to as the sustain electrodes or the X electrodes Xₙ where n is 1, 2, 3 . . . ) operating with the scan electrodes 24 to sustain the discharge within the discharge cells 8R, 8G, and 8B.

The scan electrodes 24 may be provided at centers of the discharge cells 8R, 8G, and 8B and extending in the direction crossing the address electrodes 12 (the X axis direction). The sustain electrodes 26 may be arranged at both sides of the scan electrodes 24 within the respective discharge cells 8R, 8G, and 8B, also extending in the direction crossing the address electrodes 12 (the X axis direction), and independently of the neighboring discharge cells 8R, 8G, and 8B in the Y axis direction.

The scan electrodes 24 may comprise transparent electrodes 24a and metallic bus electrodes 24b, which may be formed on the transparent electrodes 24a to enhance their electrical conductivity.

The transparent electrode 24a may occupy most of the surface discharge area of the scan electrode 24. The area of the bus electrode 24b may be minimized within an allowable range for voltage application, thereby minimizing an amount of light intercepted by the bus electrode 24b. Furthermore, since visible light may be weakly formed at the center of the discharge cells 8R, 8G, and 8B, opaque bus electrodes 24b may be placed over the center of the discharge cells, thereby preventing the deterioration in light emission luminance.

Although not shown, the sustain electrodes 26 may also comprise transparent electrodes and metallic bus electrodes. The sustain electrodes 26 of the first exemplary embodiment may be processed through one step when forming the bus electrodes 24b, thereby simplifying the processing steps of the PDP.

Consequently, the transparent and bus electrodes 24a and 24b of the scan electrodes 24 may be laminated on the second substrate 4, and the sustain electrodes 26 may be formed on the same plane as the bus electrodes 24b.

Accordingly, each discharge cell may comprise a first sustain electrode 26, the scan electrode 24, and a second sustain electrode 26. As shown in FIG. 2, a first arrangement of the sustain electrode 26, the scan electrode 24 and the sustain electrode 26 is made at a discharge cell 8R, 8G, or 8B, and a second arrangement of the sustain electrode 26, the scan electrode 24 and the sustain electrode 26 is made at the neighboring discharge cell 8R, 8G, or 8B. The sustain electrodes 26 provided at both sides of the discharge cells 8R, 8G, and 8B may be arranged independently from each other. As shown in FIG. 4, surface discharges may occur between the scan electrode 24 and each of the sustain electrodes 26 in the discharge cells 8R, 8G, and 8B, thereby enhancing light emission efficiency. The discharge gaps G1 and G2 may be established to be the same such that uniform sustain discharges may be made within the discharge cells.

The above-structured PDP may be controlled by various drive signals. A case of commonly controlling the two sustain electrodes 26 provided at each side of the discharge cell will be now illustrated.

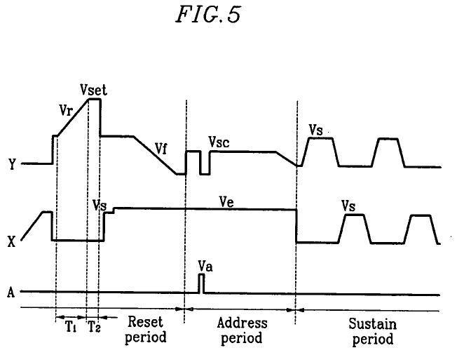

FIG. 5 is a diagram showing drive signals for driving a PDP according to an exemplary embodiment of the present invention.

Referring to FIG. 5, a common voltage may be applied to the two sustain electrodes 26, and voltages corresponding to the respective periods may be applied to the scan electrodes 24, that is, the reset signal in the reset period, the scan pulse in the address period, and the discharge sustain pulse in the sustain period. The drive signal for the sustain or X electrodes 26 is indicated in FIG. 5 as being applied to one X electrode, but it is commonly applied to both 10 sustain electrodes of a discharge cell.

A frame may be divided into a plurality of subfields, and each subfield may include a reset, address, and sustain period.

The reset period is for forming wall charges with proper polarities to the address, scan, and sustain electrodes A, Y, and X and for controlling the distribution of the wall charges is such that the subsequent address period may be fluently performed.

When the sustain discharge of one subfield terminates, a reset operation in a following reset period may include applying a slowly rising ramp pulse, increasing to the voltage Vₑ, to the sustain electrodes X. The signal applied to the scan electrode Y and the address electrode A may be maintained at 0V during application of this rising ramp pulse.

With the T1 period, the rising ramp voltage Yᵣ that slowly ascends from a voltage of less than the discharge firing voltage with respect to the sustain electrodes X to a voltage of more than the discharge firing voltage may be applied to the scan electrode Y.

During the last half period of the reset period, the sustain electrodes X may be maintained at the constant voltage Ve, and a falling ramp voltage that slowly descends from the voltage of less than the discharge firing voltage may be applied to the scan electrode Y.

When the ramp voltage descends, a slight reset discharge may occur at all discharge cells from the sustain electrodes X to the scan electrode Y. Consequently, the negative (−) wall charges on the scan electrode Y and the positive (+) wall charges on the sustain electrodes X may weaken so that a small amount of negative (−) wall charges accumulate at the scan electrode Y and the sustain electrodes X. Furthermore, a slight discharge may occur between the address and scan electrodes A and Y, and the positive (+) wall charges of the address electrode A are set up for the subsequent addressing operation.

After the reset is made before the scanning, opposite polarity voltages may be applied to the sustain electrodes X and the scan electrode Y so that a small amount of negative (−) wall charges may accumulate at the sustain electrodes X and a large amount of negative (−) wall charges may accumulate at the scan electrode Y. The positive (+) wall charges are still accumulated at the address electrodes 12 after the sustain discharge is made.

In this state, applying the scan voltage V_{sc} to the scan electrode Y and the address voltage Vₐ to the address electrode A may generate an address discharge between them, thereby dividing the discharge cells into addressed and non-addressed cells.

With the addressed discharge cells, a small amount of negative (−) wall charges may be present at the address electrodes A due to the address voltage Va, and the positive (+) wall charges accumulated thereon may migrate to the scan electrodes Y so that a large amount of positive (+) wall charges accumulate at the scan electrodes and a large amount of negative (−) wall charges accumulate at the sustain electrodes X.

With the non-addressed cells, a large amount of positive (+) wall charges may remain at the address electrodes A. Hence, a small amount of negative (−) wall charges may be present at the sustain electrodes X and a large amount of negative (−) wall charges may be present at the scan electrodes Y.

In this state, alternately applying the discharge sustain voltage Vs to the scan and sustain electrodes Y and X of the addressed discharge cells may generate a sustain discharge between them.

As described earlier, two sustain electrodes 26 may be provided at a discharge cell 8R, 8G, or 8B, and a scan electrode 24 may be disposed between the two sustain electrodes 26 to form the discharge gaps G1 and G2 therebetween. Accordingly, as the sustain discharge occurs at the two locations within the discharge cell, the resulting visible light may be significantly increased compared to the discharge sustain voltage further applied to the sustain electrodes 26 (that is, compared to the increase in power consumption), thereby enhancing the efficiency of the PDP.

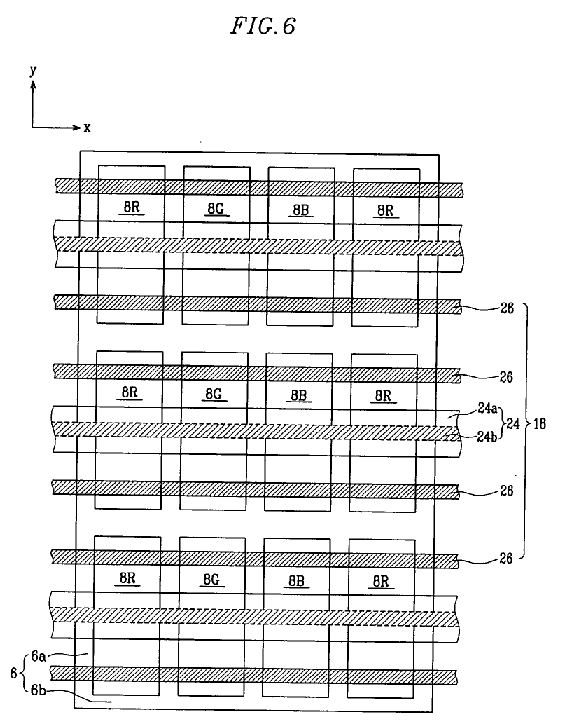

FIG. 6 is a partial plan view of a PDP according to a second exemplary embodiment of the present invention.

As the structure and operation of the PDP according to the second exemplary embodiment are similar to or identical with those of the PDP according to the first exemplary embodiment, specific explanations thereof will be omitted, and only distinguishing features of the second exemplary embodiment will be explained.

That is, with the panel structure according to the first exemplary embodiment, the discharge cells 8R, 8G, and 8B are shaped as octagons. However, referring to FIG. 6, the panel structure according to the second exemplary embodiment has rectangular shaped discharge cells 8R, 8G, and 8B. That is, the first and the second barrier rib members 6a and 6b cross each other perpendicularly. The structures of the barrier ribs and the discharge cells are not limited to those shown in the first and the second exemplary embodiments since they may be altered in various manners.

As described above, a first electrode (a scan or Y electrode) may be placed at the center of a discharge cell, and a pair of second electrodes (sustain or X electrodes) may be arranged at both sides of the discharge cell independently of the neighboring discharge cells so that the sustain discharge is made at two locations of the discharge cell within the sustain discharge period. In this way, brightness may be significantly increased with enhanced light emission efficiency, compared to the relatively low increase in power consumption due to the further application of the sustain discharge voltage to the pair of second electrodes.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a first substrate and a second substrate facing each other;
address electrodes formed on the first substrate;
barrier ribs arranged between the first substrate and the second substrate to define discharge cells; and
display electrodes arranged on the second substrate in a direction crossing the address electrodes, wherein the display electrodes comprise a first display electrode and a second display electrode;
wherein the first display electrode is formed at a discharge cell and in between second display electrodes; and
wherein the second display electrodes are arranged at both sides of the discharge cell independently of neighboring discharge cells.
wherein the display electrodes comprise a first display electrode provided at a discharge is cell and in between second display electrodes, and
wherein the second display electrodes are arranged at both sides of the discharge cell independently of neighboring discharge cells

2. The PDP of claim 1, wherein the first display electrode extends over a center of the discharge cell.

3. The PDP of claim 1, wherein the first display electrode comprises a transparent electrode and a bus electrode formed on the transparent electrode.

4. The PDP of claim 3, wherein the second display electrodes comprise bus electrodes.

5. The PDP of claim 4,
wherein the transparent electrode and the bus electrode of the first display electrode are laminated on the second substrate, and
wherein the bus electrodes of the second display electrodes are placed at a same plane as the bus electrode of the first display electrode.

6. The PDP of claim 1, wherein an arrangement of the second electrode-the first electrode-the second electrode at each discharge cell is repeatedly made at the second substrate.

7. The PDP of claim 1, wherein the barrier ribs have a closed structure for defining separate discharge cells.

8. The PDP of claim 7, wherein the barrier ribs comprise:
first barrier rib members proceeding parallel to the address electrodes; and
second barrier rib members proceeding perpendicular to the address electrodes.

9. The PDP of claim 7, wherein the barrier ribs comprise:
first barrier rib members proceeding parallel to the address electrodes; and
second barrier rib members crossing the address electrodes and interconnecting the first barrier rib members.

10. The PDP of claim 1, wherein the barrier ribs define open discharge cells.

11. The PDP of claim 10, wherein the barrier ribs are parallel to the address electrodes.

12. A method of driving a plasma display panel, the plasma display panel comprising first and second substrates, address electrodes formed on the first substrate, first electrodes formed on the second substrate while crossing the address electrodes, and second electrodes formed at both sides of each discharge cell while interposing the first electrode independently of the neighboring discharge cells, the method comprising:
dividing a frame into a plurality of sub-fields comprising a reset period, an address period, and a sustain period;
applying a reset signal to the first electrode and the second electrodes within the reset period;
applying a scan signal and an address pulse to the first electrode and the address electrode within the address period, respectively; and
applying a sustain discharge pulse alternately to the first electrode and the second electrodes within the sustain period.

13. The method of claim 12, wherein a sustain discharge pulse with a same voltage is applied to the second electrodes within the sustain period.
